(19) United States
(12) Patent Application Publication
(10) Pub. No.: US 2022/0291884 A1
(43) Pub. Date: Sep. 15, 2022

(54) PRINT REQUEST MANAGEMENT

(71) Applicant: Hewlett-Packard Development Company, L.P., Spring, TX (US)

(72) Inventors: Anusha, Bangalore (IN); Devi Vellingiri, Bangalore (IN); Puviyarasu Velumani, Bangalore (IN)

(21) Appl. No.: 17/456,697

(22) Filed: Nov. 29, 2021

(30) Foreign Application Priority Data
Mar. 15, 2021 (IN) 202141010875

(51) Int. Cl. G06F 3/12; H04N 1/00

(52) U.S. Cl. CPC G06F 3/1256; G06F 3/1211; G06F 3/1235; G06F 3/1219; H04N 1/00411

(57) ABSTRACT

An example image forming apparatus may include a processor and a memory coupled to the processor. The memory may include a quality acknowledgment-based print module to receive a print request including a document to be printed. The document may include a first page and a second page. Further, the quality acknowledgment-based print module may estimate an amount of print material coverage for the first page and the second page and select a page from the first page and the second page based on the estimated amount of the print material coverage. Furthermore, the quality acknowledgment-based print module may print the selected page on a print medium. Further, the quality acknowledgment-based print module may receive a user input via a user interface in response to printing the selected page and manage an execution of the print request in accordance with the user input.

### BACKGROUND

Image forming apparatuses may be capable of performing functions such as printing documents, scanning documents, copying documents, and/or the like. An image forming apparatus may be a single function peripheral (SFP) or a multi-function peripheral (MFP). Example SFP may include a printer, a copier, or the like that may perform one of the functions. Example MFP can incorporate the functionality of multiple devices in one, to perform a combination of some or all of a printer, a scanner, a photocopier, and the like. Such image forming apparatuses may be capable of performing the functions based on user-defined setting information.

### BRIEF DESCRIPTION OF THE DRAWINGS

Examples are described in the following detailed description and in reference to the drawings, in which:

FIG. 1 is a block diagram of an example image forming apparatus including a quality acknowledgment-based print module to manage an execution of a print request;

FIG. 2 depicts an example document associated with the print request, including a first page and a second page;

FIG. 3 is an example user interface, depicting an example notification including multiple user-selectable options to manage the execution of the print request;

FIGS. 4A and 4B illustrate another example user interface, depicting example notifications to seek a user input to manage the execution of the print request;

FIG. 5 is a block diagram of an example image forming apparatus including a processor to manage an execution of a copy request;

FIG. 6 depicts an example document associated with the copy request, including a first page and a second page;

FIG. 7 is a flowchart illustrating an example method for managing a print request based on a user selected input; and

FIG. 8 is a block diagram of an example server including non-transitory machine-readable storage medium storing instructions to manage a print request.

### DETAILED DESCRIPTION

An image forming apparatus (e.g., a single function peripheral (SFP) or a multi-function peripheral (MFP)) may be capable of performing different functions. The functions may include printing documents, scanning documents, copying documents, and/or the like. For example, the image forming apparatus may execute a print/copy request in accordance with user-defined setting information. The print/copy request may include a document (e.g., including multiple pages) to be printed. Further, a print quality may depend on various factors such as a type of a print medium, a device (e.g., a printer, scanner, and/or the like) used to perform the function, setting information, and/or the like. For example, the print quality may depend on parameters such as a contrast setting, a darkness setting, ink density of the print content, legibility of the print content, and/or the like.

In order to print the document with an acceptable print quality, one option may be to print the complete document and check whether the print quality is as expected. Another option may be to cancel the print/copy request during the printing of the document when a user identifies an unacceptable print quality. In both the scenarios, if the print quality is not acceptable, the user may have to modify the setting information of the image forming apparatus, retrigger the print/copy request, and analyze the printed output. Thus, the user may end up printing the document multiple times to obtain the acceptable print quality. However, printing the document multiple times may lead to a wastage of toner/ink, print medium (i.e., paper), and user's time, thereby affecting user experience.

In other examples, the user may print a page (e.g., a first page, a middle page, or any page) of the document as a sample to check the print quality. Upon printing the sample page, the user may end up printing remaining pages of the print/copy request assuming the print quality would be good. However, the print quality of some of the pages may not be acceptable as the sample page may not be the one which consumes a maximum or heavy toner/ink compared to other pages. Thus, printing of such test prints may affect productivity and also results in a wastage of toner/ink, media, and the like.

Examples described herein may provide an image forming apparatus to manage print/copy requests. The image forming apparatus may receive a print/copy request to print a document having multiple pages. Further, the image forming apparatus may estimate an amount of print material coverage for each page in the document and select a page having a maximum amount of print material coverage from the document. Furthermore, the image forming apparatus may print the selected page on a print medium. Upon printing the selected page, the image forming apparatus may provide at least one user-selectable option on a user interface and receive a user input via the user-selectable option. Further, the image forming apparatus may manage an execution of the print/copy request in accordance with the user input.

In an example, the image forming apparatus may execute the print/copy request to print remaining pages of the document when the user input indicates a user acceptance of a print quality of the selected page. In another example, the image forming apparatus may discard the execution of the print/copy request when the user input indicates a user refusal of the print quality of the selected page. In yet another example, the image forming apparatus may enable to modify setting information to execute the print/copy request when the user input indicates a user decision to change the setting information. Thus, examples described herein may enable the image forming apparatus to determine a maximum print material coverage page of a print/copy request and print the maximum print material coverage page prior to executing the print/copy request. Thus, examples described herein may reduce/avoid the wastage of toner/ink, print media, and/or user's time, and thereby enhancing the user experience.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

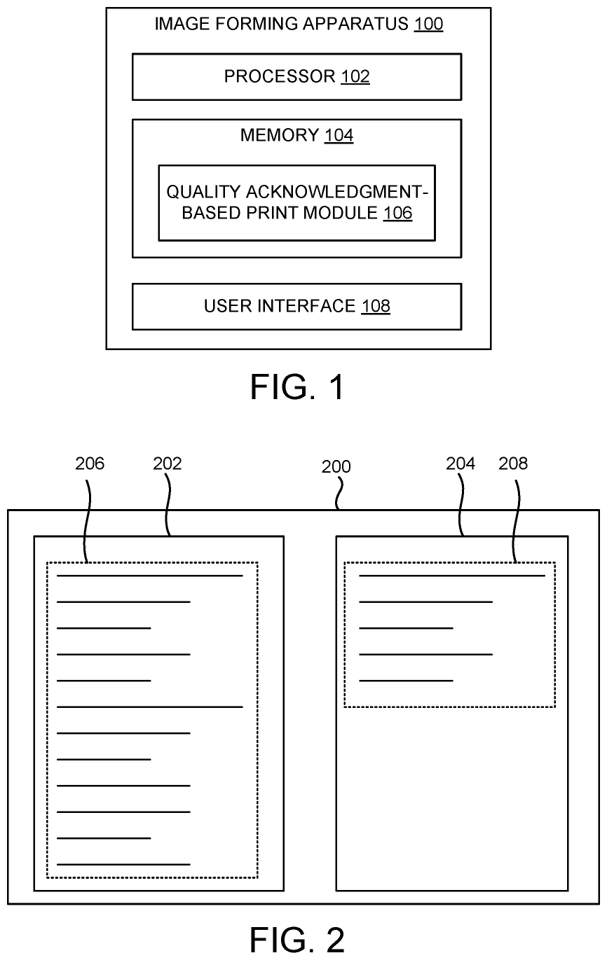

Turning now to the figures, FIG. 1 is a block diagram of an example image forming apparatus 100 including a quality acknowledgment-based print module 106 to manage an execution of a print request. Example image forming apparatus 100 may be a single function peripheral (SFP) or a multi-function peripheral (MFP). For example, image forming apparatus 100 can be a laser beam printer (e.g., using an electrophotographic method for printing), an ink jet printer (e.g., using an ink jet method for printing), or the like.

Example image forming apparatus 100 may include a processor 102 and a memory 104 coupled to processor 102. Processor 102 may be any type of central processing unit (CPU), microprocessor, or processing logic that interprets and executes machine-readable instructions stored in memory 104. Further, memory 104 may include quality acknowledgment-based print module 106.

During operation, quality acknowledgment-based print module 106 may receive a print request including a document to be printed. Example print request may include the document to be printed in accordance with setting information. The setting information may include a quality setting such as color or black/white, resolution, halftone or binary image, contour enhancement, and/or the like. In an example, the document may include a first page and a second page. An example document 200 including a first page 202 and a second page 204 may be depicted in FIG. 2. In the example shown in FIG. 2, first page 202 and second page 204 may include content 206 and 208, respectively, to be printed.

In an example, image forming apparatus 100 may receive the print request from a user device corresponding to a user. The user device may be communicatively connected to image forming apparatus 100 via a network. Example network may be a local area network (LAN), a wide area network (WAN), the Internet, and/or the like. The user device may be an electronic device supporting a printing application to generate the print request. For example, the user device may be a laptop, a desktop, a mainframe computer, a smartphone, a personal digital assistant (PDA), an Internet of Things (IoT) device, or the like. Further, the user device may include a printer driver (e.g., to support the printing application) that is either installed in or accessible to the user device to generate the print request and send the print request to image forming apparatus 100 for printing.

In another example, image forming apparatus 100 may include an email-based print function which allows the user to print the document by emailing the document to an email address associated with image forming apparatus 100. In yet another example, image forming apparatus 100 may include a read-slot (e.g., a universal serial bus (USB) interface) to receive a memory card (e.g., an SD™ card (Secure Digital card), a CompactFlash™, flash drives having a USB interface, or the like), in which electronic documents to-be-printed are stored. Furthermore, a print request associated with the electronic documents may be triggered through a user interface 108 (e.g., a control panel) of image forming apparatus 100.

Further, quality acknowledgment-based print module 106 may estimate an amount of print material coverage for the first page and the second page. In an example, the print material coverage may indicate an amount of print material that can be consumed to print each of the first page and the second page. In the example FIG. 2, the amount of print material that can be consumed to print each of first page 202 and second 204 may be determined. For example, quality acknowledgment-based print module 106 may estimate the amount of print material coverage for first page 202 by determining a ratio of a number of pixels to be printed to a total number of printable pixels in first page 202. Similarly, quality acknowledgment-based print module 106 may estimate the amount of print material coverage for second page 204 by determining a ratio of a number of pixels to be printed to a total number of printable pixels in second page 204.

In an example, quality acknowledgment-based print module 106 may estimate a percent coverage of each page, e.g., a ratio of black pixels to total number of pixels on the printable area of the page. The total number of printable pixels may include the total number of pixels on the printable area of the page and may depend on a size of the selected page (e.g., A4 size). The number of pixels to be printed per page may be determined from a count of image pixels that are received from the user device. Particularly, each pixel value that is received by quality acknowledgment-based print module 106 may be indicative of a spot which may have ink/toner applied. Each such pixel value may be counted, and the count may be used to provide an indication of the amount of ink/toner used for the respective page.

Furthermore, quality acknowledgment-based print module 106 may select a page from the first page and the second page based on the estimated amount of the print material coverage. In an example, quality acknowledgment-based print module 106 may select the page having a maximum amount of print material coverage from the first page and the second page based on the estimation. In an example, the print material coverage may be a sum of color print material coverages when the print request is a color print job. In another example, the print material coverage may be a black print material coverage when the print request is a monochrome black print job. Example print material coverage may be a toner coverage or an ink coverage. In the example shown in FIG. 2, first page 202 may be selected for printing as first page 202 may include the maximum amount of print material coverage compared to second page 204.

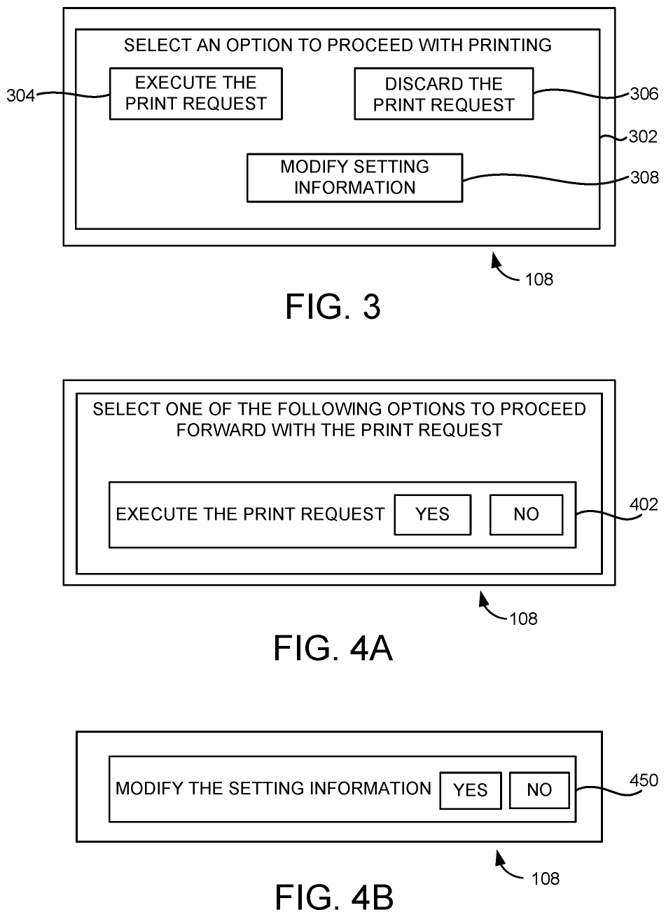

Upon selecting the page, quality acknowledgment-based print module 106 may print the selected page on print medium (e.g., a paper). Further, quality acknowledgment-based print module 106 may generate a notification on user interface 108 (e.g., of image forming apparatus 100) in response to printing the selected page. The notification may seek a user input to execute the print request, discard the print request, or modify setting information to execute the print request. In other examples, the notification may also be sent to the user device that is used to initiate the print request. An example user interface 108 depicting the notification is described in FIGS. 3, 4A, and 4B.

Furthermore, quality acknowledgment-based print module 106 may receive the user input via user interface 108 in response to printing the selected page. Further, quality acknowledgment-based print module 106 may manage the execution of the print request (e.g., execute the print request, discard the print request, or enable to modify the setting information) in accordance with the user input.

In some examples, the functionalities described herein, in relation to instructions to implement functions of quality acknowledgment-based print module 106 and any additional instructions described herein in relation to the storage medium, may be implemented as engines or modules including any combination of hardware and programming to implement the functionalities of the modules or engines described herein. The functions of quality acknowledgment-based print module 106 may also be implemented by a processor. In examples described herein, processor may include, for example, one processor or multiple processors included in a single device or distributed across multiple devices.

FIG. 3 is an example user interface 108 of FIG. 1, depicting an example notification 302 including multiple user-selectable options to manage the execution of the print request. Example user interface 108 may be a display panel of image forming apparatus 100. In an example, upon printing the selected page (e.g., first page 202 of FIG. 2), notification 302 may be displayed on user interface 108. As shown in FIG. 3, notification 302 may include different user-selectable options (e.g., options 304, 306, and 308). In an example, notification 302 may provide a first option 304 to continue executing the print request. The print request may be executed, for instance, to print the remaining pages when first option 304 is selected. In this example, second page 204 may be printed.

Further, notification 302 may provide a second option 306 to discard the print request. In this example, printing of second page 204 may be terminated. Furthermore, notification 302 may provide a third option 308 to modify setting information corresponding to the print request. In this example, when third option 308 is selected, the user may be provided with other options on user interface 108 to modify the setting information of the print request. Further, based on the modified setting information, the print request may be retriggered.

FIGS. 4A and 4B illustrate another example user interface 108, depicting example notifications 402 and 450, respectively, to seek a user input to manage the execution of the print request. In an example, upon printing a selected page (e.g., first page 202 of FIG. 2), processor 102 (e.g., as shown in FIG. 1) generate a first notification 402 on user interface 108. Example first notification 402 may seek confirmation to continue or discard the execution of the print request. In an example, upon receiving the user input to continue the execution of the print request, the print request may be executed, for instance, to print the remaining pages. For example, second page 204 may be printed.

In another example, upon receiving the user input to discard the execution of the print request, a second notification 450 may be generated on user interface 108 as shown in FIG. 4B. Example second notification 450 may seek user input to modify setting information. In an example, upon receiving the user input to modify the setting information, the user may be provided with other options on user interface 108 to change the setting information of the print request. Further, based on the modified setting information, the print request may be executed. In another example, upon receiving the user input to not to modify the setting information, the print request may be discarded. In this example, execution of second page 204 may be discarded.

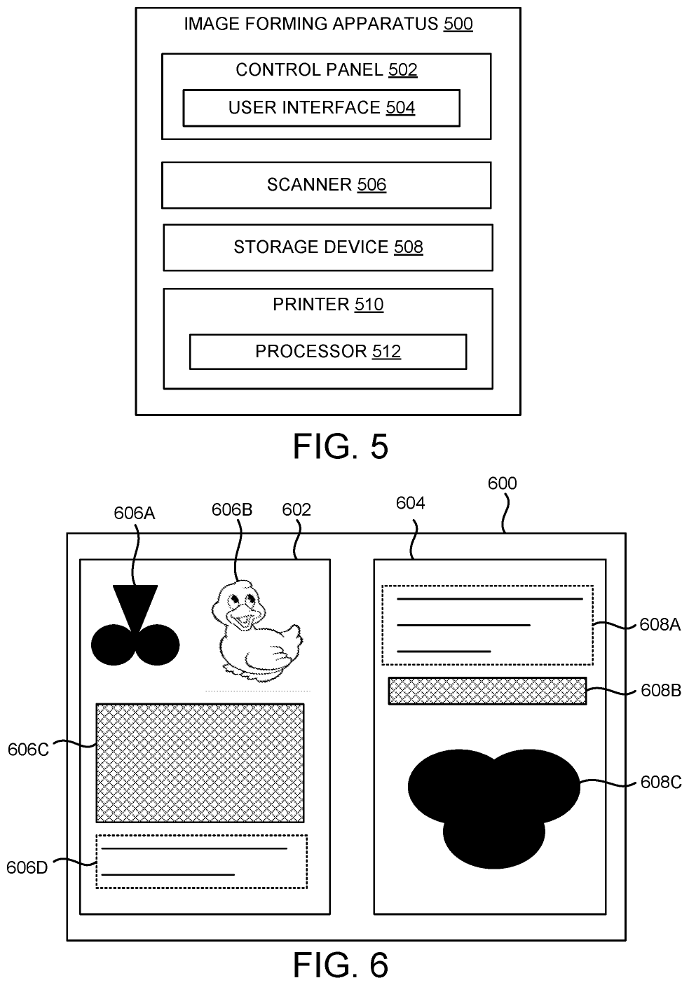

FIG. 5 is a block diagram of an example image forming apparatus 500 including a processor 512 to manage an execution of a copy request. Example image forming apparatus 500 may be a multi-function peripheral (MFP) including a scanner 506 (a flatbed scanner, a sheetfed scanner, or the like) and a printer 510. As shown in FIG. 5, image forming apparatus 500 may include a control panel 502 to receive a request to copy a document having multiple pages. Further, image forming apparatus 500 may include scanner 506 to scan the document in response to the request. Further, image forming apparatus 500 may include a storage device 508 to store the scanned document (e.g., electronic raw data representing the document). The electronic raw data may be generated by image forming apparatus 500 based on maximum values of setting information. In an example, the electronic raw data may include minimally processed image data from an image sensor of scanner 506. The purpose of the electronic raw data may be to save the image data obtained from the image sensor with minimum or no loss of information.

Furthermore, image forming apparatus 500 may include printer 510 capable of printing the scanned document. Printer 510 may include processor 512. During operation, processor 512 may estimate an amount of print material coverage for each page of the scanned document. Further, processor 512 may select a page having a maximum amount of print material coverage from the scanned document based on the estimation. In an example, for each page, processor 512 may:
detect a number of objects in a page,
determine a type of the detected objects within the page,
determine an amount of dot area coverage in a region of the detected objects, and
estimate the amount of print material coverage for the page based on the number of objects within the page, the type of the objects, and the amount of dot area coverage for the objects.

Furthermore, processor 512 may print the selected page on a print medium in accordance with setting information. An example document 600 having first page 602 and second page 604 is depicted in FIG. 6. Example first page 602 may include objects 606A-606D and second page 604 may include objects 608A-608C. For example, first page 602 and second page 604 may include monochrome contone objects, color contone objects, monochrome text objects, color text objects, monochrome line art objects, color line art objects, monochrome graphic objects, color graphic objects, monochrome low frequency halftone objects, color low frequency halftone objects, monochrome high frequency halftone objects, color high frequency halftone objects, monochrome solid fill objects, color solid fill objects, and/or the like. Further, an “object” may refer to color critical content contained within the document. The objects may be positioned on a background, composed of white space or other uniformly colored background and include, for example, text, pictures, graphics, charts, images, and the like.

Consider that the amount of print material coverage for first page 602 may be greater than the amount of print material coverage for second page 604 based on the number of objects within first page 602 and second page 604, the type of the objects, and the amount of dot area coverage for the objects as shown in FIG. 6. The “print material coverage” may be the total number of pixels of the objects in a page and/or the area of the objects in the page.

Upon printing the selected page (e.g., first page 602), processor 512 may provide, on a user interface 504 of control panel 502, a set of user-selectable options to manage an execution of the request. Further, processor 512 may manage the execution of the request in response to receiving a user input via a user-selectable option of the set of user-selectable options.

In an example, processor 512 may execute the request to print remaining pages of the scanned document when the selected option indicates a user acceptance of a print quality of the selected page. In another example, processor 512 may discard the execution of the request when the selected option indicates a user refusal of the print quality of the selected page.

In yet another example, processor 512 may enable to modify the setting information to execute the request to copy the document when the selected option indicates a user decision to change the setting information. Further, processor 512 may receive modified setting information to execute the request to copy the document via user interface 504 of image forming apparatus 500. Furthermore, processor 512 may reinitiate the copy job and repeat the process of printing, providing, and managing using the modified setting information.

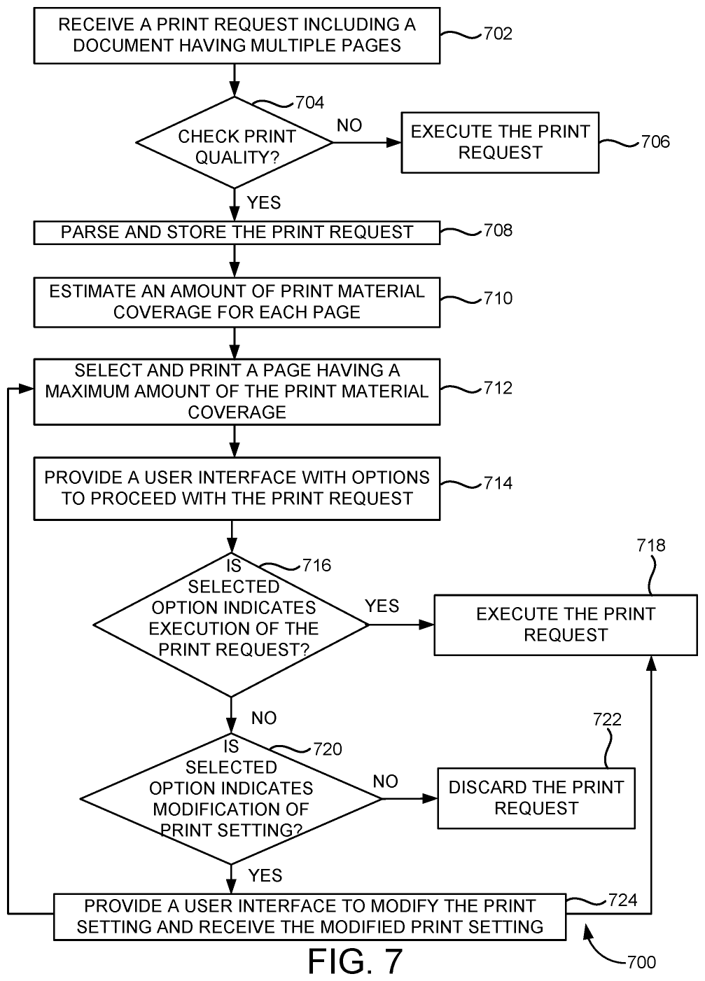

FIG. 7 is a flowchart illustrating an example method 700 for managing a print/copy request based on a user selected input. Example method 700 may represent generalized illustrations, and that other processes may be added, or existing processes may be removed, modified, or rearranged without departing from the scope and spirit of the present application. In addition, the processes may represent instructions stored on a computer-readable storage medium that, when executed, may cause a processor to respond, to perform actions, to change states, and/or to make decisions. The processes of method 700 may represent functions and/or actions performed by functionally equivalent circuits like analog circuits, digital signal processing circuits, application specific integrated circuits (ASICs), or other hardware components associated with the system. Furthermore, example method 700 may not be intended to limit the implementation of the present application, but rather example method 700 may illustrate functional information to design/fabricate circuits, generate machine-readable instructions, or use a combination of hardware and machine-readable instructions to perform the illustrated processes.

At 702, a print/copy request including a document having multiple pages may be received by an image forming apparatus. In an example, the image forming apparatus may receive the print request from a user device via a wired connection (e.g., a USB connection) or a wireless connection (e.g., server-based printing, cloud-based printing, or the like). In another example, the image forming apparatus may receive the print request from the user device via an email (e.g., email-based printing). In yet another example, the image forming apparatus may receive the print request via a control panel of the image forming apparatus (e.g., walk-up USB printing). In other examples, the image forming apparatus may receive the copy request to copy the document via the control panel.

At 704, a check may be made to determine whether the print request includes an instruction to check quality of a print. In other words, the check may be made to determine whether a “quality acknowledged print” option is selected while generating the print request. When the “quality acknowledged print” option is not selected, the print request may be executed to print the document, at 706. When the “quality acknowledged print” option is selected, the print request may be parsed and stored, at 708. For example, the multiple pages of the document corresponding to the print request may be parsed and stored in the image forming apparatus.

At 710, an amount of print material coverage (e.g., ink/toner coverage) may be estimated for each page of the document upon parsing the print request. At 712, a page having a maximum amount of print material coverage may be selected from the multiple pages and the selected page may be printed. In an example, the amount of print material coverage may be estimated based on objects in the multiple pages. For example, while generating the print request, the print driver may generate the print job with objects. Further, the objects may include text stream, images, or other multimedia elements. The colors used for the objects may be mentioned in an array. Furthermore, the objects may have color values associated with each stream of data. From the color values of each objects, print material coverage for each page may be calculated in red, green, and Blue (RGB) format. Furthermore, the values may get converted to cyan magenta yellow black (CMYK). Based on coverage value in CMYK, the page with the maximum amount of print material coverage can be identified.

Further, as the identified page would be the maximum ink/toner consuming page, the identified page can be printed first. Upon printing the selected page, a user interface with multiple user-selectable options may be provided to proceed with the print request, at 714. Thus, the user can check the quality of the printed page and then decide whether to proceed with the print request. User can then take the decision to continue printing, change a print setting, or discard the print job in the image forming apparatus.

At 716, a check may be made to determine whether the selected option indicates an execution of the print request. When the user selected option indicates to execute the print request, the print request may be executed, at 718. In this example, the user may accept the quality of the printed page, so remaining pages of the document may be printed. When the selected option does not indicate to execute the print request, a check may be made to determine whether the selected option indicates to modify a print setting corresponding to the print request, at 720. When the user selected option does not indicate to modify the print setting, the print request may be discarded, at 722. When the user selected option indicates to modify the print setting, a user interface may be provided to modify the print setting and the modified print setting may be received, at 724.

In an example, based on the received modified print setting, the print request may be executed to print the document (e.g., as shown in block 718). In another example, if a quality check may have to be made before executing the print request with the modified print setting, the user may select “quality acknowledged print” option while modifying the print setting. In this example, method 700 may goes to 712 and repeat the process shown in bocks 712 to 724 with the modified print setting.

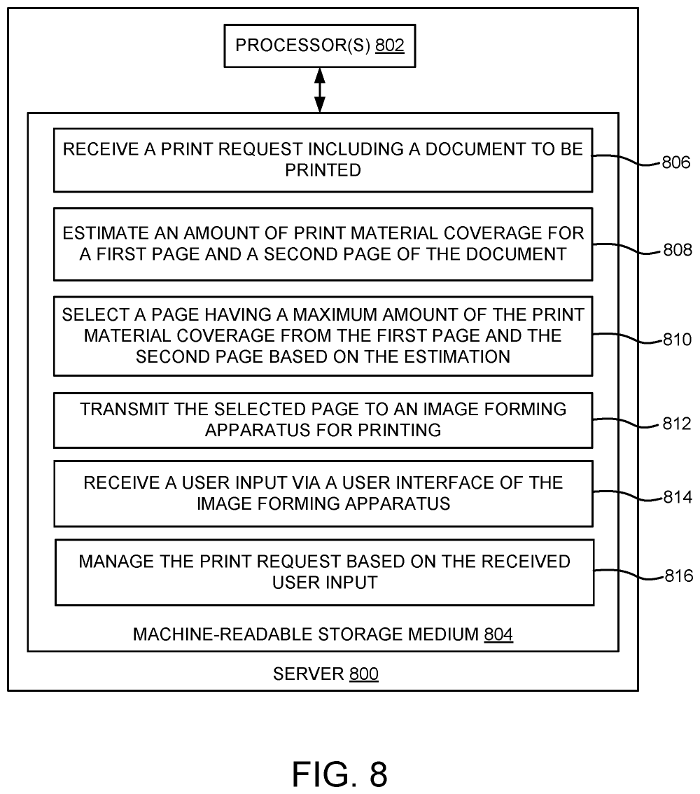

FIG. 8 is a block diagram of an example server 800 including non-transitory machine-readable storage medium 804 storing instructions to manage a print request. Example server 800 may be a device that connect image forming apparatuses to user devices over a network. Example server 800 may act as an intermediary between the user devices and image forming apparatuses, accepting print requests from the user devices and sending them on to an appropriate image forming apparatus. In some examples, server 800 may be an on-premise server or a cloud-based server (e.g., including a cloud printing service). Server 800 may include a processor 802 and machine-readable storage medium 804 communicatively coupled through a system bus. Processor 802 may be any type of central processing unit (CPU), microprocessor, or processing logic that interprets and executes machine-readable instructions stored in machine-readable storage medium 804.

Machine-readable storage medium 804 may be a random-access memory (RAM) or another type of dynamic storage device that may store information and machine-readable instructions that may be executed by processor 802. For example, machine-readable storage medium 804 may be synchronous DRAM (SDRAM), double data rate (DDR), rambus DRAM (RDRAM), rambus RAM, etc., or storage memory media such as a floppy disk, a hard disk, a CD-ROM, a DVD, a pen drive, and the like. In an example, machine-readable storage medium 804 may be non-transitory machine-readable medium. Machine-readable storage medium 804 may be remote but accessible to server 800.

As shown in FIG. 8, machine-readable storage medium 804 may store instructions 806-816. In an example, instructions 806-816 may be executed by processor 802 to execute a print request. Instructions 806 may be executed by processor 802 to receive the print request including a document to be printed. The document may include a first page and a second page.

Instructions 808 may be executed by processor 802 to estimate an amount of print material coverage for the first page and the second page. In an example, instructions 808 to estimate the amount of print material coverage for the first page and the second page may include instructions to:
estimate, for the first page of the document to be printed, the amount of print material to be used to dispose content of the first page on a print medium; and
estimate, for the second page of the document to be printed, the amount of print material to be used to dispose content of the second page on the print medium.

Instructions 810 may be executed by processor 802 to select a page having a maximum amount of print material coverage from the first page and the second page based on the estimation. Instructions 812 may be executed by processor 802 to transmit the selected page to the image forming apparatus for printing.

Instructions 814 may be executed by processor 802 to receive a user input via a user interface of the image forming apparatus. In an example, server 800 may instruct the image forming apparatus to print the selected page on a print medium. Further, server 800 may instruct the image forming apparatus to generate a notification on the user interface in response to printing the selected page. The notification may seek a user input to execute the print request, discard the print request, or modify setting information to execute the print request. Instructions 816 may be executed by processor 802 to manage the print request based on the received user input. In an example, instructions 816 to manage the print request may include instructions to transmit the print request to the image forming apparatus for printing the document when the received user input indicates an acceptance of a print quality of the selected page. In another example, instructions 816 to manage the print request may include instructions to discard the print request when the received user input indicates a user refusal of a print quality of the selected page.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and/or any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. An image forming apparatus comprising:
a processor; and
a memory coupled to the processor, wherein the memory comprises a quality acknowledgment-based print module to:
receive a print request including a document to be printed, the document including a first page and a second page;
estimate an amount of print material coverage for the first page and the second page;
select a page from the first page and the second page based on the estimated amount of the print material coverage;
print the selected page on a print medium;
receive a user input via a user interface in response to printing the selected page; and
manage an execution of the print request in accordance with the user input.

2. The image forming apparatus of claim 1, wherein the quality acknowledgment-based print module is to:
select the page having a maximum amount of print material coverage from the first page and the second page based on the estimation.

3. The image forming apparatus of claim 1, wherein the quality acknowledgment-based print module is to:
generate a notification on the user interface in response to printing the selected page, wherein the notification is to seek the user input to execute the print request, discard the print request, or modify setting information to execute the print request.

4. The image forming apparatus of claim 1, wherein the quality acknowledgment-based print module is to:
estimate the amount of print material coverage for the first page by determining a ratio of a number of pixels to be printed to a total number of printable pixels in the first page; and
estimate the amount of print material coverage for the second page by determining a ratio of a number of pixels to be printed to a total number of printable pixels in the second page.

5. The image forming apparatus of claim 1, wherein the print material coverage comprises a toner coverage or an ink coverage.

6. The image forming apparatus of claim 1, wherein the print material coverage is a sum of color print material coverages when the print request is a color print job, or wherein the print material coverage is a black print material coverage when the print request is a monochrome black print job.

7. An image forming apparatus comprising:
a control panel to receive a request to copy a document having multiple pages;
a scanner to scan the document in response to the request;
a storage device to store the scanned document; and
a printer capable of printing the scanning document, the printer comprising a processor to:
estimate an amount of print material coverage for each page of the scanned document;
select a page having a maximum amount of print material coverage from the scanned document based on the estimation;
print the selected page on a print medium in accordance with setting information;
provide, on a user interface of the control panel, a set of user-selectable options to manage an execution of the request in response to printing the selected page; and
manage the execution of the request in response to receiving a user input via a user-selectable option.

8. The image forming apparatus of claim 7, wherein the processor is to:
execute the request to print remaining pages of the scanned document when the selected option indicates a user acceptance of a print quality of the selected page.

9. The image forming apparatus of claim 7, wherein the processor is to:
discard the execution of the request when the selected option indicates a user refusal of a print quality of the selected page.

10. The image forming apparatus of claim 7, wherein the processor is to:
enable to modify the setting information to execute the request to copy the document when the selected option indicates a user decision to change the setting information;
receive modified setting information to execute the request to copy the document via the user interface; and
repeat the process of printing, providing, and managing using the modified setting information.

11. The image forming apparatus of claim 7, wherein the processor is to:
for each page:
detect a number of objects in a page;
determine a type of the detected objects within the page;
determine an amount of dot area coverage in a region of the detected objects; and
estimate the amount of print material coverage for the page based on the number of objects within the page, the type of the objects, and the amount of dot area coverage for the objects.

12. A non-transitory computer-readable storage medium encoded with instructions that, when executed by a processor of a server, cause the processor to:
receive a print request including a document to be printed, the document including a first page and a second page;
estimate an amount of print material coverage for the first page and the second page;
select a page having a maximum amount of print material coverage from the first page and the second page based on the estimation;
transmit the selected page to an image forming apparatus for printing;
receive a user input via a user interface of the image forming apparatus; and
manage the print request based on the received user input.

13. The non-transitory computer-readable storage medium of claim 12, wherein instructions to manage the print request comprise instructions to:
transmit the print request to the image forming apparatus for printing the document when the received user input indicates an acceptance of a print quality of the selected page.

14. The non-transitory computer-readable storage medium of claim 12, wherein instructions to manage the print request comprise instructions to:
discard the print request when the received user input indicates a user refusal of a print quality of the selected page.

15. The non-transitory computer-readable storage medium of claim 12, wherein instructions to estimate the amount of print material coverage for the first page and the second page comprise instructions to:
estimate, for the first page of the document to be printed, the amount of print material to be used to dispose content of the first page on a print medium; and
estimate, for the second page of the document to be printed, the amount of print material to be used to dispose content of the second page on the print medium.
